(19) United States
(12) Patent Application Publication
(10) Pub. No.: US 2008/0030329 A1
(43) Pub. Date: Feb. 7, 2008

(54) A Security System

(76) Inventors: Kevin L. Whaley, Lafayette, NC (US); Christine D. Blacker, Lafayette, NC (US)

Correspondence Address: ADVANTIA LAW GROUP, 9035 SOUTH 1300 EAST, SUITE 200, SANDY, UT, 84094, US

(21) Appl. No.: 11/462,293

(22) Filed: Aug. 3, 2006

(51) Int. Cl. G08B 13/14; G08B 1/08

(52) U.S. Cl. 340/568.1; 340/539.1

(57) ABSTRACT

A security system for tracking lost or stolen items as they breach a perimeter. There is: a response unit module, coupleable to an object to be tracked, and configured to provide a response to a signal; an activation module, in communication with the response unit module, and configured to activate a response of the response unit module by monitoring the location of the response unit module and sending a signal to the response unit module when the response unit module breaches a perimeter; and a tracking module, in communication with the activation module and the response unit module, and configured to track a location of the response unit module when the response unit breaches the perimeter.

### BACKGROUND OF THE INVENTION

1. Field of the Invention

The present invention relates to relates to an apparatus for locating a plurality of items. Specifically, it relates to a system for tracking lost or stolen items leaving a perimeter or boundary of stores, buildings, etc.

2. Description of the Related Art

In the related art, it has long been known to use an electronic apparatus or system that affords a unique method of identifying the location of a plurality of missing or lost items. Objects that are easily lost include television remote controls, portable telephones, check books, purses, etc. Searching for lost or misplaced objects is often a very time-consuming task. Similarly, in the retail management arena, the tracking of items, such as clothing or stock parts for manufacturing purposes often requires inventory-taking. If an item can not be located (e.g., an article of clothing, tools, electronic devices, or a manufacturing part of particular characteristics) then a sale may be lost or a manufacturing order goes unfilled. Moreover, the business manager may order supplemental items, not knowing that a supply item exists on the premises in some unidentified location. Since the beginning of history, people have sought to solve this problem in many ways by devising methods to help keep track of useful objects. The following are examples of related art that are provided herein for their related teachings, and are herein incorporated by reference for their supportive teachings:

U.S. Pat. No. 6,674,364, issued to Holbrook et al., discloses systems and devices for enabling persons to locate lost or misplaced objects and items in households, offices, and other work places. Such devices and items may include remote-control devices for television sets, VCR's, calculators, and miniature dictating machines. The apparatus comprises a wireless transmitter for producing a unique digital signal or data packet for a codable wireless receiver coded to respond only to the specific transmitter to cause the coded receiver to emit an audio signal or sound from a sound generating device for locating a misplaced object.

U.S. Pat. No. 5,939,981, issued to Renney, is a device which functions to locate pre-selected items which are remote from a user. The device comprises two parts; a hand held device and multiple sensors/chips which are applied to objects the user desires to locate. The hand held devices contains a control panel selector buttons for each multiple sensors/chip it is desired to locate. When a pre-selected button is depressed, a transmitter sends signal containing pre-selected code. The signal is received by a receiver in each multiple sensors/chip. The receiver in each multiple sensors/chip reads the code and if a match is obtained the receiver enables an audio tone generator in the multiple sensors/chip to send a tone through an audio speaker. The multiple sensors/chip further, transmits a signal to the hand held device which is received by a second receiver and decoded. The second receiver matches the code with the multiple sensors/chip selected and enables a second audio tone generator to send a second tone through a second speaker. Both tones are controlled to become louder the closer the hand held device is to the desired multiple sensors/chip. The multiple sensors/chip has an attachment device permitting attachment to various articles to be found. The hand held device and multiple sensors/chip are powered by a power source.

U.S. Pat. No. 5,680,105, issued to Hedrick, is an object locating system, for locating lost objects, comprising at least two response units, and at least two activation units. Each response unit corresponding to one of the objects. Each response unit having an RF receiver for receiving an encoded RF signal, a beeper, and a code program for enabling the beeper in response to the encoded RF signal. The response unit having a reset button for disabling the beeper after it has been enabled. The activation units each, having a code which corresponds to the code program in one of the response units. The activation unit having an RF transmitter which generates the encoded RF signal to enable the beeper in one of the response units. Each of the response units are color coordinated to the activation unit having the corresponding code.

U.S. Pat. No. 4,476,469, issued to Lander, is a locator means for assisting in locating an object (animate or inanimate) comprises a hand-held ‘searcher’ comprising a short-range signal transmitter powered by an internal cell or battery and having electronic circuitry for generating an address signal when activated by switching means and miniature ‘locator’ comprising a transponder powered by an internal cell or battery and having electronic circuitry and signal received from the ‘search’. The ‘searcher’ may be provided with circuitry and selective switching means for selectively addressing, with coded signals, several locators which may be placed with or on respective objects or attached thereto, e.g. by means of a small ring. The ‘searcher’ is preferably torch-like with a handle which may have a lug for attachment of a lanyard whereby the ‘searcher’ may be tethered to a mounting. The transmitter-to-transponder signaling may be by airwaves or vibrations or by electromagnetic waves preferably employing pulse position modulation. Possible forms of such transmission are described, also information as to the electronic circuitry and constructional details of a miniature locator.

U.S. Pat. No. 5,677,673, issued to Kipnis, is an apparatus for locating a plurality of objects including a plurality of receiver units. Each receiver includes a receiver housing with a first pile fastener secured to a bottom surface thereof for allowing coupling with a second pile fastener situated on an entity. A speaker is situated on the top surface of each receiver housing for transmitting an audio signal. Also included is a receiver mechanism situated within the receiver housing and connected to the speaker. Each receiver mechanism is adapted to transmit a unique audio signal via the speaker thereof upon the receipt of a unique activation signal. The second major component is a transmitter unit comprising a plurality of push button switches situated on the front face thereof. Finally, a transmitter mechanism is situated within the transmitter housing and coupled to the push button switches. The transmitter mechanism is adapted to transmit a unique activation signal corresponding to a receiver unit upon the continuous depression of a corresponding push button switch.

U.S. Pat. No. 5,798,693, issued to Engellenner, relates to methods and apparatus disclosed for location of objects to facilitate retrieval, filing, security, inventory stock-keeping and the like. The methods and apparatus employ a tag element associated with each object-to-be-located, and interrogation system for searching one or more spatial regions for such tagged items, as well as mechanisms for identifying objects within the interrogated region.

However, while such may be suitable for the particular purpose employed, or for general use, they are expensive, difficult to use, and not suitable as an anti-theft device that triggers an alarm built into the anti-theft tag itself.

What is needed is a system or method that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available security systems. Accordingly, the present invention has been developed to provide a security system for tracking lost or stolen items as they breach a perimeter by using a global positioning system (GPS).

It is a feature of one embodiment of the illustrated invention to provide a security system for tracking lost or stolen items as they breach a perimeter, including: a response unit module, coupleable to an object to be tracked, and/or configured to provide a response to a signal; an activation module, in communication with the response unit module, and/or configured to activate a response of the response unit module by monitoring the location of the response unit module and/or sending a signal to the response unit module when the response unit module breaches a perimeter; and/or a tracking module, in communication with the activation module and the response unit module, and/or configured to track a location of the response unit module when the response unit breaches the perimeter.

In another embodiment, the tracking module may be a global positioning system.

In still another embodiment, the response unit may be an alarm.

In yet another embodiment, the alarm may be an audio alarm.

In yet still another embodiment, the system further includes a control unit in connection with the activation module, configured to control activation of the activation module.

In a further embodiment, the response unit module includes: a response unit housing, configured to house the response unit, and/or including a hole; and/or a connector, coupled to the response unit module, sized smaller than the hole, enabling the connector to pass through the hole, and/or configured to connect the response unit to the object to be tracked.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a front planar view of a security system response unit according to one embodiment of the invention;

FIG. 2 illustrates a front planar view of a security system control unit according to one embodiment of the invention;

FIG. 3 illustrates a block diagram of a response unit module according to one embodiment of the invention;

FIG. 4 illustrates is a block diagram of an activation module according to one embodiment of the invention; and

FIG. 5 illustrates a flowchart outlining a method of using a security system according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one, skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

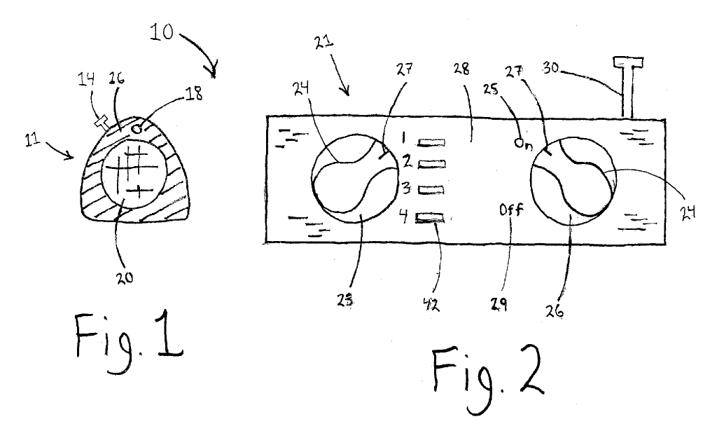

FIGS. 1 and 2 illustrate a front planar view of a security system 10 according to one embodiment of the invention. The security system includes: a response unit or module 11 (shown in FIG. 1); a control unit or module 21 (shown in FIG. 1); and associated peripherals (not shown) such as wiring, cables, global positioning system (GPS) equipment, sensors, etc.

In the illustrated embodiment, the members of the response unit 11 may include a receiving antenna 14 fixably attached to the response unit casing 16 having a hole 18 therein that is designed for users to use string, chain, etc. to attach object(s) thereon. Further, there may be a speaker or beeper cover 20 in the response unit casing 16 where an activated audio sound emanates therethrough into the air.

According to another embodiment of the invention, the illustrated security system 10 includes a control unit casing 28 having a transmitting antenna 30 and a first actuatable knob with a handle 24 and pointer 27 thereon. The first actuatable knob 23 allows a user to select amongst plurality of activation switches 42. Also, on the control unit casing 28 there may be a second actuatable knob 26 with a handle 24 and pointer 27 that is opposite the first actuatable knob 23. The second actuatable knob 26 enables a user to turn the control unit 21 in either the “On” position 25 or “Off” position 29 to activate or deactivate the activation module (AM) 22.

FIG. 3 illustrates a block diagram of a response unit module 12 according to one embodiment of the invention. The response unit module (also referred to as RUM) 12 is contained inside of the response unit casing 16 as illustrated in FIG. 1 and may include a receiving antenna 14 for receiving encoded radio frequency (RF) signals, and an RF receiver 32 for decoding the encoded RF signal under the scrutiny of a code program 34. When an RF signal is modulated by a code matching the code program 34 is received, a beeper 38 is enabled to draw attention to the RUM 12 with an object attached thereto. The beeper 38 will continue to sound until the RUM 12 is deactivated by the reset button 36. Ideally, the code program 34 is an 8 to 64 bit binary code, for preventing false triggering.

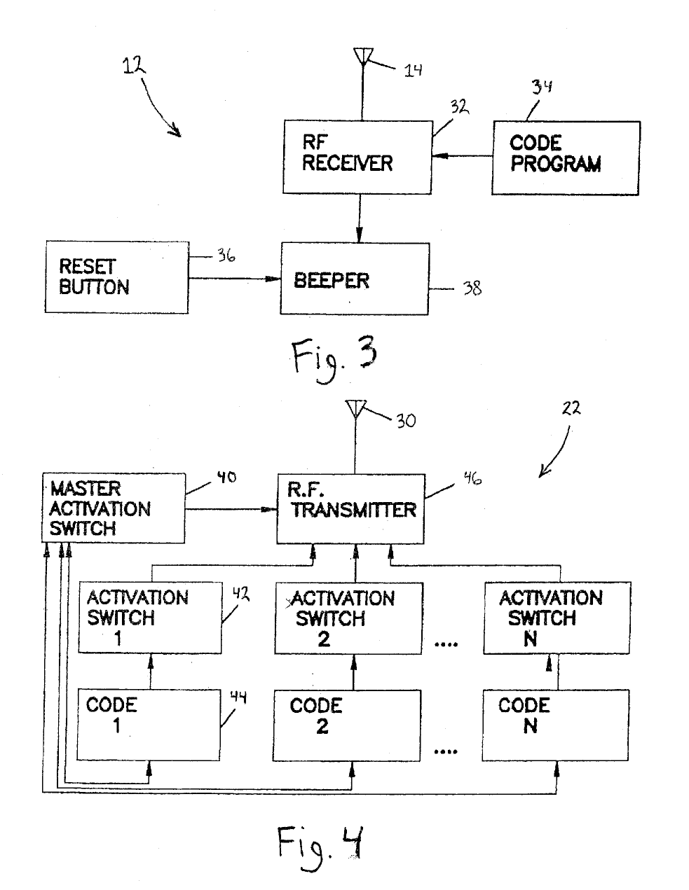

FIG. 4 illustrates a block diagram of the activation module 22 according to one embodiment of the invention. The activation module (also referred to as AM) 22 is contained inside of the control unit casing 28 shown in FIG. 1. Broadly, when the AM 22 is enabled by a plurality of activation switches or buttons 42, a RF transmitter 46 generates an encoded RF signal under the modulation of a code 44. The encoded RF signal is propagated by a transmitting antenna 30 to the receiving antenna 14. A plurality of activation switches 42 allow a plurality of codes 44 to be transmitted using the same RF transmitter 46. In addition, all codes 44 can be transmitted by the RF transmitter 46 in rapid succession through a master activation switch 40.

Further, the activation circuitry is contained within the control unit casing 28 of the control unit 22, and the activation switches 42 may be located in separate control units 22. In addition, the external member of the AM 22 may include a transmitting antenna 30 fixably attached to the control unit casing 28.

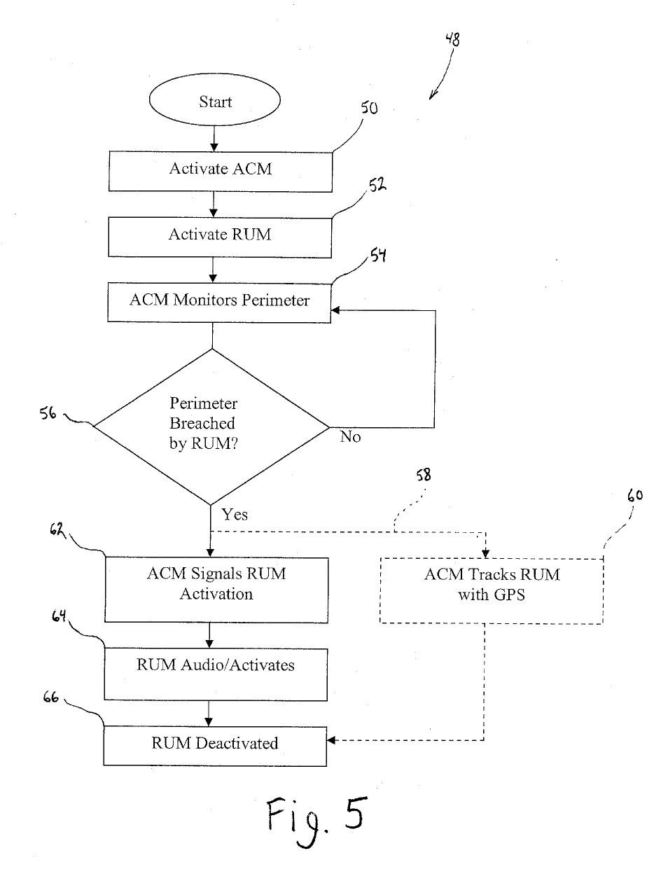

FIG. 5 illustrates a flowchart outlining a method 48 of using the security system according to one embodiment of the invention. In operation, a user may activate AM(s) 22 per step 50 by installing response unit(s) 11, control unit(s) 22, and associated peripherals (not shown) such as wiring, cables, global positioning system (GPS) equipment, sensors, etc. in and around the perimeter of a store, building, housing, etc.

After activating the AM(s) 22, the user can proceed to step 52 and activate RUM(s) 12 by threading string, chain, etc. through hole 18 in the response unit casing 16 as a means to attach selected object(s), within a certain distance of the activated AM 22, thereon.

Once the AM(s) 22 and RUM(s) 12 are activated, the AM(s) 22 coupled with wiring or cables attached to a plurality of sensors positioned in close proximity of doors, windows, walls, etc. around the perimeter of a building enables the activated AM 22 to monitor activated RUM(s) 12 positioned within the perimeter of the building according to step 54.

If RUM(s) 12 remain does not breach the perimeter of a building per step 56, audio sounds will not emanate from a beeper 38 housed in the interior of the RUM(s) 12. Instead, the AM(s) 22 will continue to monitor the RUM(s) 12 in accordance with step 54. Conversely, should the RUM(s) 12 breach the perimeter of the building as described in step 56 and go outside the designated range of the activated AM(s) 22, the AM(s) 22 will send a radio frequency signal to the RUM(s) 12 and activate such. Once the RUM(s) 12 is activated, an audio sounds or alarm will emanate from the beeper 38 inside of the response unit casing 16 according to step 64. This audio sound is designed to alert a user with an item attached to the RUM(s) 12 to return such back within the perimeter of the building. After the RUM(s) 12 is back in the perimeter of a building, it will be deactivated per step 66 and the audio sound will cease.

In another embodiment of the invention, there may be an alternative response (described in step 58) to the AM(s) 22 signaling activation of RUM(s) breaching the perimeter buildings. As depicted in step 60, the security system 10 may be designed in such a manner where the AM(s) 22 has an ability to communicate with, and track the movement of RUM(s) 12 through a tracking module, such as a GPS. It is known that GPS receivers come in a variety of formats, from devices integrated into cars, phones, watches, etc. Therefore, portable GPS receivers may be integrated with the RUM(s) 12 and AM(s) 22.

It is also known that GPS receivers are designed to maintain continuous, line of sight, radio frequency communication with a plurality of GPS satellites in orbit above the Earth's surface. It is known that a constellation of GPS satellites broadcast precise timing signals by radio to GPS receivers, allowing them to accurately determine their location anywhere on Earth. This enables the AM(s) 22 to continuously monitor and track movement of RUM(s), allowing users to accurately locate items attached to the RUM(s) 12 per step 60. Once the item is found, the RUM(s) 12 may be deactivated as described in step 66.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Although the response unit casing 16 is shaped as a parabolic segment and the illustrated control unit 28 is rectangular in shape as illustrated, one skilled in the art will realize that most any shape will be sufficient for the intended purpose of the system.

In another embodiment of the invention, the hole 18 can be positioned anywhere in the response unit casing 16, so long as it can be attached to various items.

In yet a further variation of the illustrated invention, the transmitting antenna 30 and receiving antenna 14 can be any shape and/or length, as well as be positioned anywhere on the response unit casing 16 and control unit casing 28, so long as the RUM 12 can receive radio signals transmitted from the AM 22 and activate such.

In still yet another variation of the invention, the response unit or module 11 may be a GPS receiver in the form of a bracelet that may be placed on a person, allowing such persons to be tracked, located and/or rescued should they become missing or lost. For example, missing persons can be located during camping trips, severe weather storms, etc.

In still yet another embodiment of the invention, the response unit or module 11 may be a GPS receiver in the form of a computer chip that may be placed in the interior of high-valued items such as televisions, computers, electronic devices, etc. This allows a user to track such items anywhere in the world after being misplaced or stolen. For example, a person either at home, on vacation, etc. the item may be tracked by GPS satellite.

Finally, it is envisioned that the security system 10 and/or members may be constructed of a variety of materials, such as plastic, metal, composite material, etc.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A security system for tracking lost or stolen items as they breach a perimeter, comprising:
a response unit module, coupleable to an object to be tracked, and configured to provide a response to a signal;
an activation module, in communication with the response unit module, and configured to activate a response of the response unit module by monitoring the location of the response unit module and sending a signal to the response unit module when the response unit module breaches a perimeter; and
a tracking module, in communication with the activation module and the response unit module, and configured to track a location of the response unit module when the response unit breaches the perimeter.

2. The system of claim 1, wherein the tracking module is a global positioning system.

3. The system of claim 2, wherein the response unit module is an alarm.

4. The system of claim 3, wherein the alarm is an audio alarm.

5. The system of claim 4, further comprising a control unit module, in connection with the activation module, configured to control activation of the activation module.

6. The system of claim 5, wherein the response unit module includes:
a response unit housing, configured to house the response unit, and having a hole; and
a connector, coupled to the response unit module, sized smaller than the hole, enabling the connector to pass through the hole, and configured to connect the response unit to the object to be tracked.

7. A security system for tracking lost or stolen items as they breach a perimeter, consisting essentially of:
a response unit module, coupleable to an object to be tracked, and configured to provide a response to a signal;
an activation module, in communication with the response unit module, and configured to activate a response of the response unit module by monitoring the location of the response unit module and sending a signal to the response unit module when the response unit module breaches a perimeter;
a tracking module, in communication with the activation module and the response unit module, and configured to track a location of the response unit module when the response unit breaches the perimeter; and
a control unit module, in connection with the activation module, configured to control activation of the activation module.

8. The system of claim 7, wherein the tracking module is a global positioning system.

9. The system of claim 8, wherein the response unit module is an alarm.

10. The system of claim 9, wherein the alarm is an audio alarm.

11. The system of claim 10, wherein the response unit module includes:
a response unit housing, configured to house the response unit, and having a hole; and
a connector, coupled to the response unit module, sized smaller than the hole, enabling the connector to pass through the hole, and configured to connect the response unit to the object to be tracked.
